(19) United States
(12) Patent Application Publication
(10) Pub. No.: US 2004/0001138 A1
(43) Pub. Date: Jan. 1, 2004

(54) Stereoscopic panoramic video generation system

(76) Inventors: W.A. Chaminda P. Weerashinghe, Bella Vista (AU); Philip Ogunbona, Fairy Meadow (AU); Wanqing Li, Hurstville (AU)

Correspondence Address: MOTOROLA, INC., 1303 EAST ALGONQUIN ROAD, IL01/3RD, SCHAUMBURG, IL, 60196

(21) Appl. No.: 10/183,210

(22) Filed: Jun. 27, 2002

(51) Int. Cl. H04N 7/00

(52) U.S. Cl. 348/36; 348/42

(57) ABSTRACT

A method and apparatus for stereoscopic panoramic video generation includes novel techniques for panorama projection, stitching and calibration for various depth planes. The apparatus includes a polygonal camera head (40) having multiple sides (42) and a circular projection center (44) located within the polygon. Each side of the polygon has a pair of cameras (46a, 46b) for capturing image scenes. The cameras (46a, 46b) are arranged such that image projection lines (48) extending from the cameras are perpendicular to the side upon which the camera is located and tangent to one side of the circle of the projection center. Projection surfaces (50) are warped such that the image projection lines are also perpendicular to the projection surfaces. Stereoscopic panoramic video is generated with no occlusion of the scene by the capturing apparatus and no visible perspective errors or image mosaic artifacts.

### BACKGROUND OF THE INVENTION

The present invention relates generally to recording, generating and displaying video images of static and dynamic scenes and, more particularly, to a panoramic viewing system and generating stereoscopic panoramic images.

A stereoscopic or three-dimensional image for human visualization is made up of two images of a scene from two slightly horizontally displaced positions. The captured images are meant to imitate the way people see. When a person looks at an object each eye sees a slightly different view and the brain fuses these views together into a single, three-dimensional image. Thus, one of the captured images is presented to the left eye and the other to the right eye.

A panoramic image is an image of a scene having a wide field of view, up to a complete 360 degrees around a chosen point in space. A panoramic image can be generated by recording many images around a single point and then creating an image mosaic spanning the recorded scene.

Generally, panoramic images are formed from still scenes at far depth planes, whereas stereoscopic images are formed from dynamic scenes at near depth planes. Due to these differences, fusion of panoramic and stereoscopic imaging poses both a scene dynamics dilemma and depth plane inconsistency. That is, it is required to capture both near and far depth plane information from two distinct points in space, along every possible direction over 360-degree field of view.

Capturing an image along each of the directions over 360 degrees requires thousands of cameras to be placed around each of the two points in space. Such a system is impractical. Instead of thousands of cameras, a single rotating camera can be placed at one of the two points in space to capture thousands of images over a long period of time and then moved to the second point to repeat the image capture. Alternatively, two rotating cameras can be placed at the two distinct points, to halve the image capture time. However, this will create occlusion from the cameras on each other. Instead of just rotating two cameras, reflective surfaces can be carefully placed around the cameras to simultaneously capture images along multiple directions. However, this will also create occlusion by the reflective surfaces on each other. Further, the placement of the reflective surfaces requires very high accuracy. Furthermore, such single and dual camera systems are limited to static scenes and are not adequate for capturing dynamic scenes.

Monoscopic panorama generation using multiple images of a scene, and image mosaic techniques is known. However, systems for generating a stereoscopic panorama are not yet well developed. One known system uses a rotating camera on a vertical shaft. Left and right image portions (strips) are extracted digitally from each image frame assuming a slit camera model. These strips are merged separately to generate left and right panoramas. However, to avoid stitching artifacts, only a very thin strip from each image frame can be used, hence thousands of images are required to generate a single panorama. When the strip width increases, registration errors increase. Further, physical constraints negate the use of multiple cameras, since accommodation of many cameras on the camera rig (vertical shaft) is cumbersome. Although an alternative system using multiple rigs and thus, multiple cameras has been proposed, the number of cameras is too few to produce the same results as using a rotating camera, even with additional mirrors.

The rotating camera system does not permit dynamically changing environments, such as an auto race, to be captured. Alternative systems using special mirrors and lenses have been developed for generating video rate stereoscopic panoramic movies. However, such systems are complex and expensive for a number of reasons, including the lenses and mirrors must be custom made with complicated spiral shapes; high accuracy on reflective/refractive surfaces are essential for minimizing image distortions; since the panorama is optically compressed onto a single camera frame, the resolution of the image content is compromised; loss of signal strength, due to multiple reflection and refraction; occlusion of part of one view due to the mirror/lens arrangement of the other view; and distortion of perspective and disparity information.

Another known system uses pyramidal reflective surfaces instead of spiral mirrors or special lenses. However, this system is also affected by the disadvantages described above. Thus, although multi-camera systems for generating monoscopic panoramas are available, currently, there are no multi-camera systems or projection methods available for generating stereoscopic panoramic video content of dynamic scenes that do not employ rotating cameras or additional reflective/refractive surfaces.

Monocular panoramic images are created by a perspective projection, where scene points are projected onto the image surface along projection lines passing through a single point, called the “projection center” or the “viewpoint”. In general, a finite number of “N” images are captured in a stationary environment, and stitched together to produce the panoramic image. This is called image based rendering (IBR).

IBR generates new images from the captured images, instead of traditional primitives like polygons. This offers several advantages over polygon-based rendering, such as constant rendering time for images independent of scene complexity; rendering of very complex (photo-realistic) images using less computational power compared to polygon-based rendering; and the ability to use digitized photographs to create virtual environments instead of modeling an environment using geometric means, etc. However, when IBR is used for panorama generation, several assumptions are made on the environment in which the images are captured. For example, if a single camera is used, it is assumed that there is a static environment and objects, same illumination conditions over time, objects are sufficiently far away from the camera, and that there is sufficient overlap between the captured images. If multiple cameras are used, it is assumed that either the cameras are synchronized or there is a static environment and objects, all cameras have equivalent gain and color characteristics, objects are sufficiently far away from the camera, and there is sufficient overlap between the captured images.

Stereo panoramic images are created by multiple-view-point projection, where both the left-eye image and the right-eye image share a common projection surface. To enable stereo perception, the left-eye and the right-eye are located on an inner viewing-circle inside the projection image surface and the viewing direction is on a line tangent to the viewing circle.

Generally, two projection methods are used for panorama generation, central projection and circular projection. Central projection is used for generating a monoscopic panorama, while circular projection is used for generating a stereoscopic panorama.

Referring now to FIG. 1, a diagram for illustrating the central projection method applied to a rotating camera or multiple cameras arranged on a circular head is shown. More particularly, scene points are projected onto a circular projection surface 10 from a projection center 12 along projection lines 14. The projection lines 14 pass through the projection center 12. As shown in the drawing, the directions of the captured image frames are perpendicular to the projection surface 10. Since the central projection method requires a projection center, the number of cameras that can be located at the projection center is limited and only a monoscopic image can be generated.

FIG. 2 is a diagram illustrating the circular projection method applied to a rotating camera. In order to generate a stereoscopic image, the method has right and left circular projection surfaces 20. Scene points are projected onto the projection surfaces 20 from respective projection circles 22 along projection lines 24. Although the captured image frames in the central projection method are perpendicular to the projection surface 10, the captured image frames in the circular projection method are not perpendicular to the projection surface 20. In order to generate a stereoscopic panorama, a large number of captured frames per camera are required. However, since the method is suitable for a rotating double camera system rather than a multi-camera system, it is not suitable for dynamic video capture. Further, central projection is used when displaying left and right panoramas, requiring disparity adjustment.

It would be beneficial to be able to generate stereoscopic panoramic video images of dynamic scenes with no occlusion of the scene in a simple and inexpensive manner.

### BRIEF DESCRIPTION OF THE DRAWING

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a diagram illustrating a conventional central projection method;

FIG. 2 is a diagram illustrating a conventional circular projection method;

FIG. 3 is a diagram illustrating a centro-circular projection method in accordance with the present invention;

FIG. 4 is a schematic diagram of a preferred embodiment of a camera head in accordance with the present invention;

FIG. 5 is a top view diagram of an image warping geometry of the centro-circular projection method of FIG. 3;

FIG. 6 is a side view diagram of the image warping geometry of FIG. 5;

FIG. 7 is a diagram of a blend stitching geometry for the centro-circular projection method of FIG. 3;

FIG. 8 is a diagram of image-frame merging at a merge point;

FIG. 9 is a diagram of a projection error from two different viewpoints;

FIG. 10 is a functional block diagram of an image pre-processing stage of a viewing system in accordance with the present invention; and

FIG. 11 is a functional block diagram of an image warping and stitching stage of a viewing system in accordance with the present invention.

### DETAILED DESCRIPTION OF THE INVENTION

In the drawings, like numerals are used to indicate like elements throughout.

The present invention provides a Centro-Circular Projection method for stereoscopic panoramic video generation that combines the favorable features of both the aforedescribed central and circular projection methods for a specific camera set-up. The present invention provides a method and apparatus for stereoscopic panoramic video generation including novel techniques for panorama projection, stitching and calibration for various depth planes. The present invention is useful for generating a stereoscopic panorama of dynamic scenes, using a limited number of multiple pairs of cameras or multiple stereoscopic cameras mounted on a regular polygonal shaped camera rig. The present invention further includes novel techniques for panorama projection, stitching and calibration for various depth planes such that stereoscopic panoramic video is generated with no occlusion of the scene by the capturing apparatus and no visible perspective errors or image mosaic artifacts.

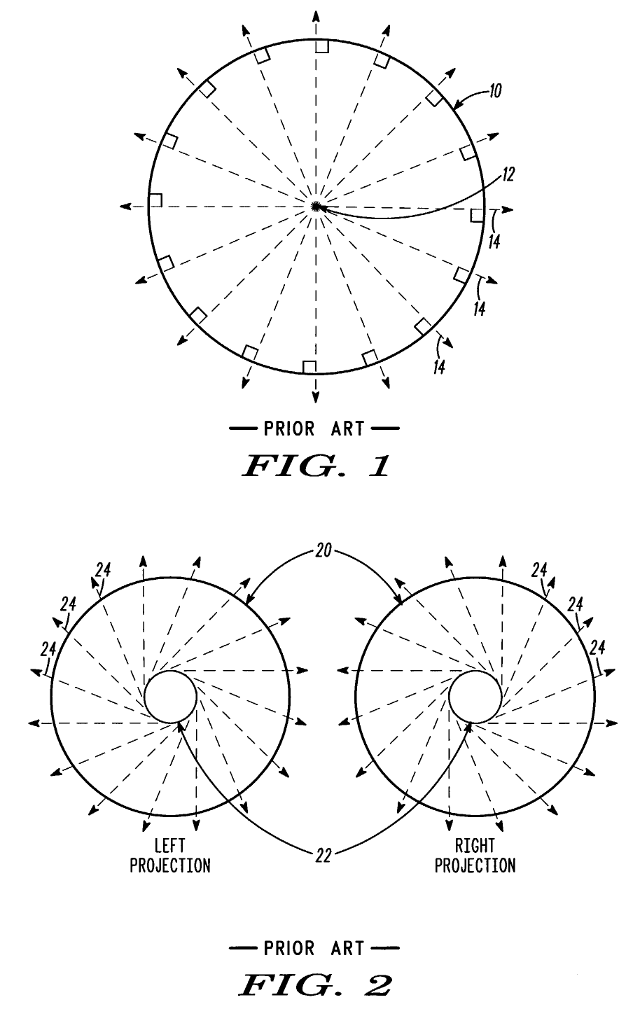

Referring now to FIG. 3, a diagram for illustrating the centro-circular projection method of the present invention is shown. As previously discussed, stereo panoramic images are created by multiple-view-point projection, where both the left-eye image and the right-eye image share a common projection surface. To enable stereo perception, the left-eye and the right-eye are located on an inner viewing-circle inside the projection image surface and the viewing direction is on a line tangent to the viewing circle. According to the present invention, the centro-circular projection method includes left and right overlapping projections 30, each of which have a plurality of image or projection surfaces 32 and a projection circle 34. Scene points are projected onto the plurality of projection surfaces 32 from the projection circles 34 along rays or projection lines 36. The projection circles 34 are similar to the projection circles 22 of the circular projection method (FIG. 2), with the camera directions being tangential to the circles 34. That is, the projection lines 36 illustrating the projection of the image from the scene to the projection surfaces 32 are tangent to the projection circles 34. However, like the central projection method (FIG. 1), the directions of the captured image frames, as illustrated with the projection lines 36, are perpendicular to respective ones of the projection surfaces 32.

One of the main features of the centro-circular projection method is that all the captured frame directions are unaltered, and perpendicular to the projection plane (i.e., the projection surfaces 32). Thus, so that the scene points are perpendicular to the projection surfaces, the projection surfaces 32 are warped to match the tangents at the overlap regions. This allows stereo pairs to be naturally rectified for parallel viewing.

The centro-circular projection method of the present invention is preferably used with a limited number of cameras arranged on a regular polygonal head. Since a limited number of cameras (say “N”) are available for image capture, there are only “N” correct perspectives available for each panorama projection. Compared to the rotating camera, where thousands of frames and hence correct perspectives are available for each panorama, with a limited number of multiple cameras, it is important to preserve the captured N true perspectives when projected on to the panoramic surface. Therefore, the present invention arranges the N camera directions perpendicular to the projection surfaces 34. Since the camera directions are perpendicular to the projection surfaces 34, there is no necessity to convert to central projection at the display or viewing stage, and the original disparity between the left and right captured image information is preserved. That is, the perspective and binocular disparity of the captured images during image mosaic generation are preserved.

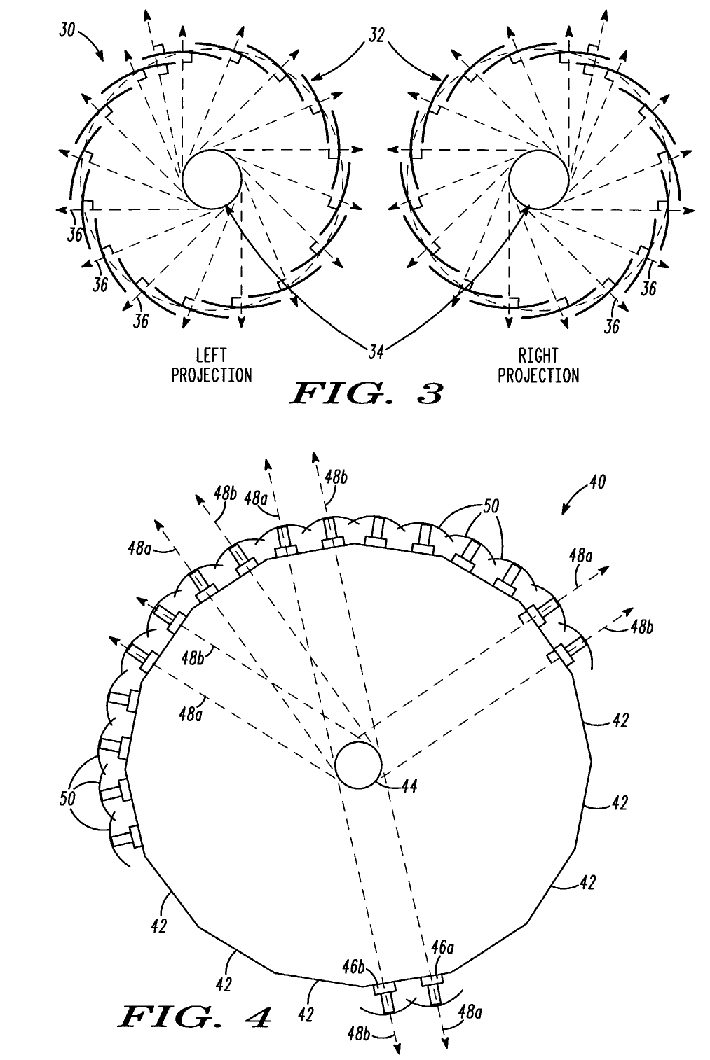

Referring now to FIG. 4, a schematic diagram of a preferred embodiment of a camera head or rig 40 in accordance with the present invention is shown. The camera head 40 is a sixteen sided polygon having sides 42 and a center projection circle 44. Each side 42 has first and second cameras 46a, 46b. For ease of illustration, not all of the sides 42 are shown with cameras 46a, 46b. The first (left) cameras 46a are positioned such that image projection lines 48a (dashed lines) extending from the cameras 46a are perpendicular to the sides 42 and tangent to one side of the circle 44. The second (right) cameras 46b are positioned such that image projection lines 48b (dashed lines) extending from the cameras 46b are also perpendicular to the sides 42 and tangent to an opposing side of the circle 44. Thus, both the first and second cameras 46a, 46b are located such that the image projection lines extend along lines 48a, 48b that are tangent to the projection circle 44, perpendicular to the sides 42, and perpendicular to warped projection surfaces 50. As will be understood by those of ordinary skill in the art, a camera head in accordance with the present invention can have more or fewer sides and thus, more or fewer cameras. Further, the term camera as used herein includes a variety of image capturing devices, such as analog cameras, digital cameras, stereophonic cameras, CCDs, etc.

In order to generate stereoscopic panoramic video using the perspectives captured by the limited number of cameras, the present invention further provides novel techniques for panorama projection, stitching and calibration for various depth planes.

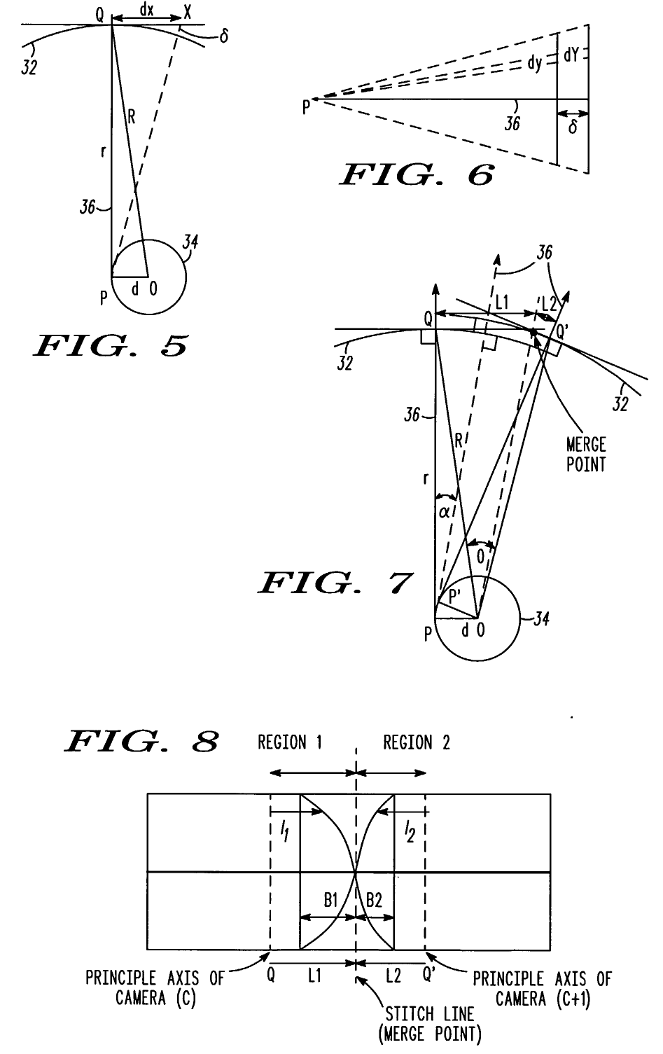

Referring now to FIGS. 5 and 6, top and side view illustrations are provided of the image warping geometry of the projection surfaces 32 for the centro-circular projection method. In the presently preferred embodiment, all of the captured image frames are warped according to Equation (1) to project on to the respective projection surface 32 for Centro-Circular projection. Equation (1), an image-warping equation, is as follows,

$$dy = \frac{r}{\sqrt{{r}^{2} + {( dx )}^{2}}} dY \qquad ( 1 )$$

Other geometric relationships depicted in FIGS. 4 and 5 are:

R=\sqrt{r²+d²} (2)

δ=\sqrt{r²+(dx)²−r} (3)

where,

O—center of a multi-camera set-up;

P—single viewing point on one of the projection circles 34;

d—half distance between the left and right cameras, which is also the radius of the projection circles 34;

Q—mid-column of a captured image frame;

P-Q—one of N camera directions;

r—minimum distance from the center O to each of the facets on the polygonal camera rig;

R—radius of the virtual panorama projection circle;

X—an arbitrary column on the captured image frame where QX=dx;

dx—radial distance between captured and projected image frames;

dy—vertical spacing of pixels on the column X, in the warped image frame 32; and

dY—vertical spacing of pixels on the column X, in the captured image frame.

The present invention includes an image processor, discussed in detail below, for processing the images captured by the camera pairs. Referring now to FIG. 7, a diagram illustrating a blend stitching geometry for the centro-circular projection method is shown. In general, if there are M number of facets on the regular polygonal camera head, the angle between two consecutive or adjacent cameras for each panorama is given by:

$$θ = \frac{{360}^{°}}{M} \qquad ( 4 )$$

Consecutive image frames are warped, as shown by the projection surfaces 32, so that camera directions at θ/2 angular intervals are perpendicular to the projection surface 32. In FIG. 7, by considering the triangle POP′, it can be shown that,

$$α = \frac{θ}{2} \qquad ( 5 )$$

Merge points for panorama stitching are defined by the parameters L1 and L2. A simple geometric analysis of FIG. 7 leads to the following,

L1=r tan α+d (6)

L2=r tan αα−d (7)

The above relationship applies to both the left and right panoramas 30. However, in the case of the left panorama, the value of d is positive, whereas for the right panorama d is negative.

In order to convert the physical distances to captured image frame pixel distances, the following equations involving the focal length of the cameras (F), image sensor pixel cell sizes CH (horizontal) and CV (vertical) are used.

$$\begin{matrix}Pixel width ( unit length ) = \frac{r \times ( CH )}{F} & ( 8 ) \\ Pixel height ( unit length ) = \frac{r \times ( CV )}{F} & ( 9 )\end{matrix}$$

It should be noted that r, CH, CV and F should be converted to the same unit lengths before applying the above equations.

Referring now to FIG. 8, a diagram for illustrating image frame merging at the merge point is shown. The blending (overlapping) region is divided into two regions as shown in FIG. 8. Blending weights are computed according to the column distance from Q and Q′ (in FIG. 7) for each of the pair of columns that needs to be blended.

For Region 1, the blending weight parameters are given by,

$${W}_{C} = 1 - 0.5 {( \frac{{I}_{1}}{L1} )}^{2} \qquad ( 10 )$$

W_{C+1}=1−W_{C} (11)

For Region 2, the blending weight parameters are given by,

$${W}_{C + 1} = 1 - 0.5 {( \frac{{I}_{2}}{L2} )}^{2} \qquad ( 12 )$$

W_{C}=1−W_{C+1} (13)

The blend stitch will generally have a maximum width of B1+B2 as shown in FIG. 8. This blend stitching technique merges two adjacent image frames smoothly across a merge point. This method is also capable of regularizing the illumination differences that may be present between two consecutive image frames. However, it is not compulsory to use this full blending width. Any arbitrary blend width (2T) can be specified on either side of the stitch line, provided that

T≦min{B1,B2} (14)

However, small T values are less effective in illumination regularization than large T values, although they inflict less ghosting artifacts at the image stitch.

It should be noted that due to the characteristic nature of “panorama”, the system can be accurately calibrated for a particular iso-plane that is at a distance of user's choice from the camera head. When objects are further away from this plane, the panoramic stitching will not be exact. However, there is always a particular depth of field, which can be achieved for a given number of cameras, where the artifacts due to mis-registration of objects of adjacent images are non-significant to human vision. This depth of field is larger for video panorama than for still panoramic images. The implication on the depth of field for different choices of calibrating iso-planes is illustrated in Table 1.

Referring now to TABLE 1, for general usage, it is recommended that the camera system be calibrated using an iso-plane in 7 m-14 m range. However, the system can also be calibrated to near objects, in which case, far objects need to be removed from the direct camera vision using opaque screens. Calibrating for a far iso-plane is both difficult to set-up and unnecessary since the stereoscopic effect will be lost due to large object distances from the camera set-up. The result would be equivalent to monoscopic panorama, which could be generated using a simpler camera set-up.

TABLE 1
Calibrating camera setup for different depth scenarios.

| Calibrating | Depth of | Artifacts (object | |
|---|---|---|---|
| iso-plane | field | mis-registration) | Stereoscopic effect |
| 0-7 m | small | High | Although the disparity is |
| (near) | | | high due to objects being |
| | | | located near the camera, |
| | | | the small depth of field |
| | | | allows only a small |
| | | | change in the object |
| | | | planes. Therefore the |
| | | | stereo effect is not |
| | | | significantly high. Ex- |
| | | | ceeding the depth of field |
| | | | will introduce mis- |
| | | | alignment artifacts at |
| | | | image stitching. |
| 15 m or more | large | Low | Although the depth of |
| (far) | | | field is high, all the |
| | | | objects are placed far |
| | | | from the camera |
| | | | setup producing small |
| | | | disparity values. There- |
| | | | fore, the stereo effect is |
| | | | not significantly high. |
| | | | Any object placed closer |
| | | | to the camera set-up than |
| | | | the depth of field will |
| | | | introduce significant |
| | | | artifacts. |
| 7 m-14 m | medium | Some | Calibrating the camera |
| (mid-range) | | | setup for mid-distance |
| | | | will produce significant |
| | | | depth of field |
| | | | while having an adequate |
| | | | disparity for stereoscopic |
| | | | visualization. Although |
| | | | some artifacts may be |
| | | | visible, there is good |
| | | | possibility of masking |
| | | | these artifacts to the |
| | | | human eyes via motion |
| | | | and monoscopic depth |
| | | | cues. |

Camera calibration is also essential because each camera within the multi-camera head should be vertically and horizontally aligned with no planar rotations on the image sensors within each camera with respect to each other.

In order to maximize the overlap image information from adjacent camera images, it is usually recommended to use wide field of view (FOV) lenses on the cameras. However, such lenses generally inflict radial distortion on the captured images. Therefore, it is recommended that radial distortion correction be performed using radial distortion parameters estimated at the camera calibration stage.

The following camera-head geometry, camera intrinsic and extrinsic parameters are generated using a one time camera calibration procedure.

1) Focal length (F)

2) Horizontal Cell Size (CH)

3) Vertical Cell Size (CV)

4) Camera angular separation (θ)

5) L and R camera separation (2×d)

6) Minimum distance from the center of the camera set-up head to each facet (r)

7) Radial distortion parameters for each camera

8) Rotation parameters for each camera

9) Vertical shift parameters for each camera

10) Horizontal shift parameters for each camera Rotation and vertical/horizontal shift corrections are performed using conventional methods known by those of ordinary skill in the art.

The first calibration step is to capture a full set of N images containing a grid pattern placed at the calibrating iso-plane. The second calibration step is to measure or obtain the following camera specifications:

1) Focal length of the camera in (mm);

2) Horizontal cell size in micro meters;

3) Vertical cell size in micro meters;

4) Camera angular separation;

5) Left and right camera separation; and

6) Minimum distance from the center of the camera set-up head to each facet (r).

In a third step, each captured image frame is used to estimate the radial distortion parameter. Since this is performed once for the camera-head, it can be a trial and error method where several values are used for distortion correction followed by visual examination of the corrected image quality. In a fourth step, the rotation parameters are estimated for each image frame using a similar method to the third step.

The fifth step is to identify the horizontal and vertical shift parameters for the cameras. Using a blend width (2×T) of 2 pixels (recall equation (14), T≦min{B1,B2}), generate a panorama using the

$$( \frac{N}{2} )$$

captured images representing the left panorama. If there are any horizontal/vertical misalignments in the cameras, each stitch will display a relative shift at the merging point. Misalignments in terms of number of pixels in both vertical and horizontal directions are carefully identified. These will become the horizontal/vertical shift parameters for each camera.

The sixth step is to generate a panorama with full blend width (B1+B2) and visually inspect whether there are visible ghosting artifacts at the stitching regions. If properly calibrated, there will be no visible stitching artifacts in these regions.

The seventh step is to repeat steps 5 and 6 for the right panorama. When calibrated for a single depth plane it is trivial to re-calibrate the set-up for a different depth plane by only changing the parameter CH and the horizontal shift parameters of each camera.

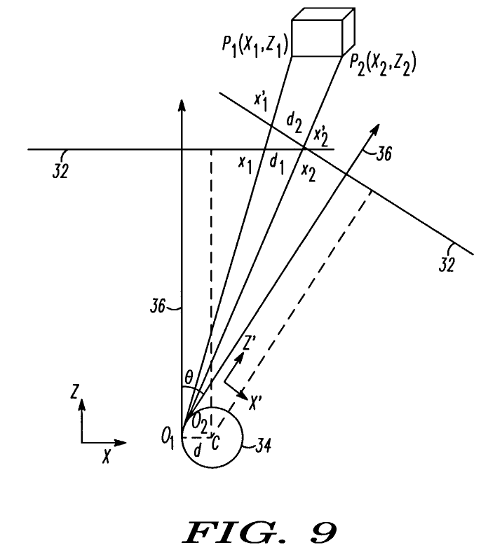

Referring now to FIG. 9, an 0₁-axis coordinates, P₁, P₂ are defined as (X₁,Z₁) and (X₂,Z₂) respectively. The conversion from 0₂-axis system to 0₁-axis system is given by

X′=X cos θ−Z sin θ+d(1−cos θ) (15)

Z′=X sin θ+Z cos θ+d sin θ

The projected coordinates x₁ and x₂ are given by

$${x}_{1} = \frac{{f}_{s}}{{Z}_{1}} \cdot {X}_{1} and {x}_{2} = \frac{{f}_{s}}{{Z}_{2}} \cdot {X}_{2} \qquad ( 16 )$$

where fₛ is the focal length of the camera lens. Hence,

$${d}_{1} = \vert {x}_{1} - {x}_{2} \vert = {f}_{s} \cdot \vert \frac{{X}_{1}}{{Z}_{1}} - \frac{{X}_{2}}{{Z}_{2}} \vert \qquad ( 17 )$$

Similarly,

$${x}_{1}^{′} = \frac{{f}_{s}}{{Z}_{1}^{′}} \cdot {X}_{1}^{′} = {f}_{s} \cdot \frac{{X}_{1} cos θ - {Z}_{1} sin θ + d ( 1 - cos θ )}{{X}_{1} sin θ + {Z}_{1} cos θ + d sin θ} = {f}_{s} \cdot \frac{\frac{{X}_{1}}{{Z}_{1}} cos θ - sin θ + \frac{d}{{Z}_{1}} ( 1 - cos θ )}{\frac{{X}_{1}}{{Z}_{1}} sin θ + cos θ + \frac{d}{{Z}_{1}} sin θ} \qquad ( 18 )$$

Assume that d<<Z₁,Z₂, which is a valid assumption in most cases. Also α₁ and α₂ are defined such that

$$\begin{matrix}\begin{matrix}tan {α}_{1} = \frac{{X}_{1}}{{Z}_{1}} and tan {α}_{2} = \frac{{X}_{2}}{{Z}_{2}} \\ Therefore ,\end{matrix} & ( 19 ) \\ \begin{matrix}{x}_{1}^{′} = {f}_{s} \cdot \frac{tan {α}_{1} cos θ - sin θ}{tan {α}_{1} sin θ + cos θ} \\ Similarly ,\end{matrix} & ( 20 ) \\ \begin{matrix}{x}_{2}^{′} = {f}_{s} \cdot \frac{tan {α}_{2} cos θ - sin θ}{tan {α}_{2} sin θ + cos θ} \\ Hence ,\end{matrix} & ( 21 ) \\ \begin{matrix}\begin{matrix}{d}_{2} = \vert {x}_{1}^{′} - {x}_{2}^{′} \vert = {f}_{s} \cdot \vert \frac{tan {α}_{1} cos θ - sin θ}{tan {α}_{1} sin θ + cos θ} - \frac{tan {α}_{2} cos θ - sin θ}{tan {α}_{2} sin θ + cos θ} \vert \\ = {f}_{s} \cdot \vert \frac{tan {α}_{1} - tan {α}_{2}}{( tan {α}_{1} sin θ + cos θ ) ( tan {α}_{2} sin θ + cos θ )} \vert\end{matrix} \\ Also ,\end{matrix} & ( 22 ) \\ {d}_{1} = {f}_{s} \cdot \vert \frac{{X}_{1}}{{Z}_{1}} - \frac{{X}_{2}}{{Z}_{2}} \vert = {f}_{s} \cdot \vert tan {α}_{1} - tan {α}_{2} \vert & ( 23 )\end{matrix}$$

The perspective error (ε) is defined by:

$$ϵ = \vert {d}_{1} - {d}_{2} \vert = {f}_{s} \cdot \vert tan {α}_{1} - tan {α}_{2} \vert \cdot \vert 1 - \vert \frac{1}{( tan {α}_{1} sin θ + cos θ ) ( tan {α}_{2} sin θ + cos θ )} \vert \vert \qquad ( 24 )$$

If the mid-point of the object has an angular locational, and the objects subtends an angle β on the projection point, the error can be re-written as,

$$ϵ = {f}_{s} \cdot \vert tan ( {α}_{x} + \frac{β}{2} ) - tan ( {α}_{x} - \frac{β}{2} ) \vert 1 - \vert \frac{1}{( tan ( {α}_{x} - \frac{β}{2} ) sin θ + cos θ ) ( tan ( {α}_{x} + \frac{β}{2} ) sin θ + cos θ )} ‖ \qquad ( 25 )$$

However, this error should be interpreted in conjunction with the weight function incorporated at the image blending stage to determine the effect of the visual ghosting artifacts.

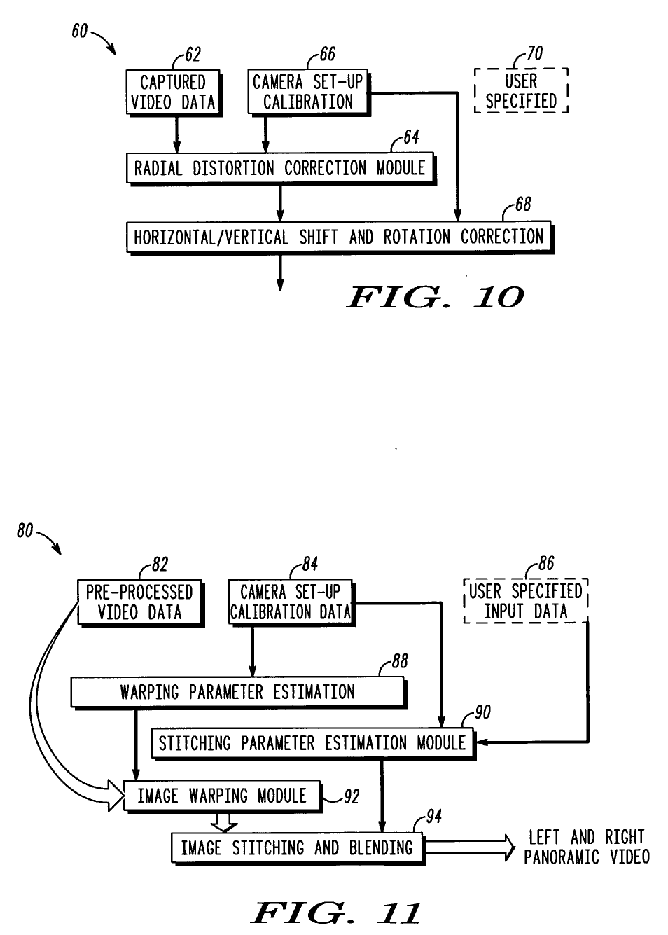

FIGS. 10 and 11 are functional block diagrams of an image processor for processing the images captured by the camera pairs, including image frame merging and determining camera focal lengths. Referring now to FIG. 10, a functional block diagram of an image pre-processing stage 60 of a viewing system in accordance with the present invention is shown. The pre-processing stage 60 receives captured video data from the cameras 46a, 46b. The captured video data may be stored in a buffer or memory 62 or fed directly to a processor or logic circuit for processing. The video data buffer 62 is connected to a radial distortion correction module 64, which receives both left and right image sequences from the buffer 62. The pre-processing stage 60 also includes a set-up data buffer or memory 66 that stores the camera set-up calibration data, which includes the radial distortion parameters estimated at the camera calibration stage previously discussed. The set-up buffer 66 is also connected to the radial distortion correction module 64. The radial distortion correction module 64 receives the left and right image sequences from the video data buffer 62 and the radial distortion parameters from the set-up data buffer 66 and generates corrected left and right image sequences. Radial distortion can be modeled using a polynomial approximation r=ρ+αρ³+βρ⁵+ . . . where r is the undistorted image radius, ρ is the radius in the distorted image, and α and β are coefficients of radial distortion. Only odd powers of ρ exist, and the distortion can usually be approximated using only the first and the third power of ρ. In order to correct for the distortion, both the equations r=ρ+αρ³ or ρ=r−αr³ can be used with equal validity. The value of α is considered as the radial distortion parameter, which is estimated at the camera calibration phase for each camera on the rig. The radial measures r and ρ are computed with respect to an origin at the mid-point on the captured image frame, and both measures are taken along the same radial directions.

The radial distortion correction module 64 has an output connected to a horizontal/vertical shift and rotation correction module 68. The shift and rotation correction module 68 receives the corrected left and right image sequences from the radial distortion correction module 64 and horizontal, vertical, and rotation parameters from the set-up buffer 66, and generates preprocessed left and right image sequences. Rotation and horizontal and vertical shift corrections are performed using conventional methods known by those of ordinary skill in the art.

The pre-processing stage 60 may also include a user specified data buffer 70 for storing data input by a user during camera set-up calibration, such as radial distortion and rotation parameters, focal length, etc. The video data buffer 62, set-up buffer 66 and user specified data buffer 70 may comprise a single memory or multiple memories, as will be understood by those of skill in the art.

Referring now to FIG. 11, a functional block diagram of an image warping and stitching stage 80 of a viewing system in accordance with the present invention is shown. The image warping and stitching stage 80 includes a pre-processed video data buffer 82 for storing the left and right image data generated by the pre-processing stage 60. The image warping and stitching stage 80 also includes a calibration data buffer 84 and a user specified input data buffer 86. The buffer 84 may be the same as the buffer 66 (FIG. 10), and stores data such as horizontal and vertical cell size(CH, CV), focal length(F), camera angular separation(θ), left and right camera separation (2×d), etc., which are determined during the calibration process previously discussed. The user specified input data buffer 86 may be the same as the buffer 70 (FIG. 10) and/or the same as the buffer 84, and is used to store further calibration process data, such as blend width and disparity adjustment.

The calibration data buffer 84 is connected to a warping parameter estimation module 88, which calculates image warping parameters. As previously discussed, consecutive image frames are warped so that camera directions at

$$\frac{θ}{2}$$

angular intervals are perpendicular to the projection surfaces. The calibration data buffer 84 is also connected to a stitching parameter estimation module 90, which calculates image stitching parameters. The user specified input data buffer 86 is also connected to the stitching parameter estimation module 90. The stitching parameter estimation module 90 calculates the merge points for left and right panoramas, in a manner discussed above.

The pre-processed video data buffer 82 and the warping parameter estimation module 88 are connected to an image warping module 92. The image warping module 92 receives the preprocessed video data and warps the captured image frames according to Equation (1), discussed above. The image warping module 92 and the stitching parameter estimation module 90 are connected to an image stitching and blending module 94, which generates and outputs the left and right panoramic video images using the warped image data generated by the image warping module 92 and the panorama height and width data and frame start and end column data frames generated by the stitching parameter estimation module.

The present invention is suitable for generating stereoscopic panoramic video of both static and dynamic scenes. However, it will be understood that the inventive concepts described herein may be applied to other applications and may be implemented with specialized hardware, software, or combinations thereof. Further, changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An apparatus for generating stereoscopic panoramic video, comprising:
a polygonal camera head having a plurality of sides;
a circular projection center located within the camera head; and
a plurality of camera pairs for capturing image scenes, wherein each side of the polygon has one of the camera pairs located thereon;
wherein the cameras are arranged such that image projection lines extending from the cameras are perpendicular to the side upon which the camera is located and tangent to one side of the circle of the projection center.

2. The stereoscopic panoramic video apparatus of claim 1, wherein the projection line for a first camera of a pair of cameras is tangent to one side of the circle of the projection center and the projection line for a second camera of the pair of cameras is tangent to a second, opposite side of the circle of the projection center.

3. The stereoscopic panoramic video apparatus of claim 1, wherein the captured image scenes are warped.

4. The stereoscopic panoramic video apparatus of claim 3, wherein the captured image scenes are warped according to the equation
$$ⅆ y = \frac{r}{\sqrt{{r}^{2} + {( dx )}^{2}}} ⅆ Y ,$$
where r is a minimum distance from a center of the projection circle to each of the sides on the polygon; dx is a radial distance between captured and projected image frames; dY is a vertical spacing of pixels on a column X in the captured image frame; X is an arbitrary column on the captured image frame; and dy is a vertical spacing of pixels on the column X in the warped image frame.

5. The stereoscopic panoramic video apparatus of claim 1, wherein each pair of cameras comprises a single stereoscopic camera.

6. The stereoscopic panoramic video apparatus of claim 1, wherein for M number of sides on the polygonal camera head, an angle between two adjacent cameras is given by
$$θ = \frac{{360}^{°}}{M} .$$

7. The stereoscopic panoramic video apparatus of claim 6, wherein consecutive image frames are warped so that camera directions at
$$\frac{θ}{2}$$
angular intervals are perpendicular to a projection surface.

8. The stereoscopic panoramic video apparatus of claim 6, further comprising an image processor coupled to each of the cameras of the plurality of camera pairs and receiving video frames from each of the cameras, wherein the image processor stitches together the video frames captured by adjacent cameras.

9. The stereoscopic panoramic video apparatus of claim 8, wherein merge points for panorama stitching are defined by parameters L1 and L2, where L1=r tan α+d and L2=r tan α−d, wherein r is a minimum distance from a center of the projection circle to each of the sides on the polygon; d is half the distance between two cameras of a camera pair; and
$$α = \frac{θ}{2} .$$

10. The stereoscopic panoramic video apparatus of claim 9, wherein for a left panorama, the value of d is positive and for a right panorama d is negative.

11. The stereoscopic panoramic video apparatus of claim 1, wherein the polygonal camera head has sixteen sides.

12. A method of generating left and right panoramic mosaic video sequences for use in providing stereoscopic panoramic viewing of a dynamic scene, comprising:
capturing left and right video images by an arrangement of multiple pairs of cameras or multiple stereoscopic cameras mounted on a regular polygonal shaped camera rig, wherein the cameras are arranged such that image projection lines extending from the cameras are perpendicular to the side upon which the camera is located and tangent to one side of a circle of a projection center located within the camera rig;
projecting the captured left and right video images onto a plurality of projection surface, wherein the projection surfaces are warped such that the captured images are projected along a line that is tangent to the circle of the projection center and perpendicular to the projection surface.

13. The method of generating left and right panoramic mosaic video sequences of claim 12, wherein the captured image scenes are warped according to the equation
$$ⅆ y = \frac{r}{\sqrt{{r}^{2} + {( dx )}^{2}}} ⅆ Y ,$$
where r is a minimum distance from a center of the projection circle to each of the sides on the polygon; dx is a radial distance between captured and projected image frames; dY is a vertical spacing of pixels on a column X in the captured image frame; X is an arbitrary column on the captured image frame; and dy is a vertical spacing of pixels on the column X in the warped image frame.
